(19) United States
(12) Patent Application Publication
(10) Pub. No.: US 2002/0123608 A1
(43) Pub. Date: Sep. 5, 2002

(54) Fluorinated polymer and coating composition

(76) Inventor: Grover Latham Howard III, Glen Waverley (AU)

Correspondence Address: BIRCH STEWART KOLASCH & BIRCH, PO BOX 747, FALLS CHURCH, VA, 22040-0747, US

(21) Appl. No.: 09/953,154

(22) Filed: Sep. 17, 2001

Related U.S. Application Data
(63) Continuation of application No. PCT/AU00/00198, filed on Mar. 17, 2000.

(30) Foreign Application Priority Data
Mar. 17, 1999 (AU) PP9246

(51) Int. Cl. C08G 73/24; B32B 27/00

(52) U.S. Cl. 528/401; 528/397; 528/403; 528/52; 428/423.1

(57) ABSTRACT

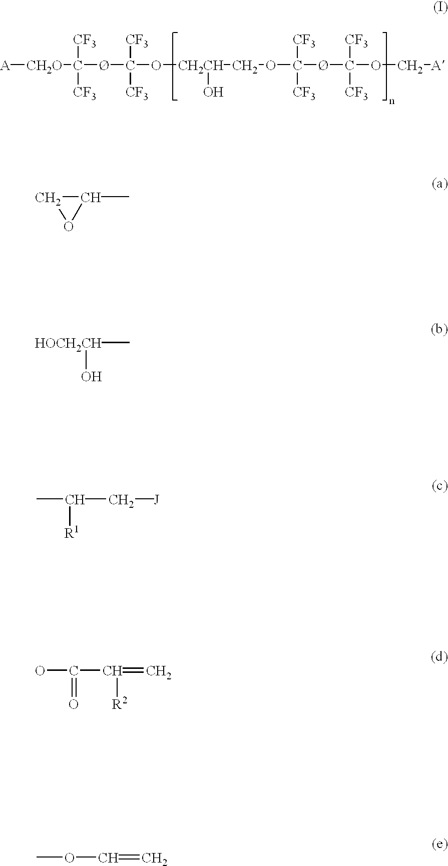

A fluoropolymer of formula (I) wherein ø is an aromatic diradical; n is an integer of at least 2; and A and A′ are independently selected from the group consisting of (a), (b) and (c), wherein R¹ is hydrogen or hydroxy and J is (d) or (e), wherein R² is hydrogen or methyl.

This invention relates to fluoropolymers, to a method of preparing a fluoropolymer and to fluoropolymer compositions such as coating compositions and plastics compositions.

It is known to produce fluorinated polymers by reaction of fluorinated diols with epichlorohydrin. Highly fluorinated polymers provide coatings which are corrosion resistant and have been used in specialist applications in military hardware. The cost of fluoropolymers is a major deterrent to their use and has precluded their use in commercial or industrial applications.

We have now developed a range of fluorinated polymers which have a high resistance to heat, light and chemical degradation which can be produced at a cost which makes them useful in industrial and commercial applications.

Accordingly we provide a fluoropolymer of Formula I

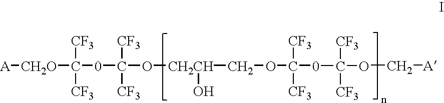

wherein

ø is an aromatic diradical;

n is an integer of at least 2; and

A and A′ are independently selected from the group consisting of

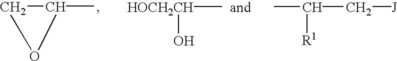

wherein R¹ is hydrogen or hydroxy and J is

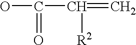

or —O—CH═CH₂

wherein R² is hydrogen or methyl.

In a preferred embodiment the fluoropolymer is of formula Ia

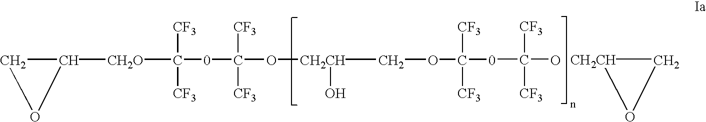

wherein ø is an aromatic diradical (preferably selected from meta- and para-diradical of benzene) and n is an integer of at least 2, preferably in the range of from 4 to 40 and more preferably from 8 to 20.

The fluoropolymer of the invention does not require an additional aliphatic monomer in order to provide efficient polymerization and excellent coating properties. Notwithstanding the hindered nature of the fluorinated monomer the polymer may be prepared efficiently and provides excellent coating properties.

U.S. Pat. Nos. 3,852,222 and 4,132,681 discloses polymers formed using bis(2-hydroxyhexafluoro-2-propyl)benzene and a comonomer either hexa-fluoropentandiol or a diol of the formula (a):

HO(CF₃)₂CCH₂CH═CHC(CF₃)₂OH (a)

While use of the Diol of the formula (a) reduces the expense of the polymer it remains significantly more expensive than can generally be justified in other than specialist military applications. It was believed, however, that these aliphatic fluorinated diols were required to provide the required flexibility on curing. Unexpectedly the present inventor found that a fluoropolymer with excellent film forming properties and resistance to degradation could be formed using the 1, 3 and/or 1, 4 isomer of bis(2-hydroxyhexafluoro-2-propyl)benzene without an aliphatic comonomer.

The fluoropolymer of the invention may be prepared by reaction of the diol of Formula I

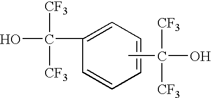

where either the 1,3- or 1,4-isomer or a mixture thereof, with epichlorohydrin and sodium hydroxide. The epichlorohydrin and sodium hydroxide are preferably in an amount of at least 10 percent excess. The relative amount of epichlorohydrin used will determine the chain length of the polymer. If the amount of epichlorohydrin is from I molar equivalent to 15% excess then a greater number of repeating units will be present (generally over 20) than if more than a 15% excess is used. A solvent such as acetone will also preferably be used.

The fluoropolymers of the invention are particularly useful in coating compositions and may be used in cross linkable polyurethane, epoxy and acrylates. Alternatively the fluoropolymers may be used iin the manufacture of plastics, compositions or adhesives.

Polyurethane resin coatings may be prepared using a polyisocyanate, such as TDI, HDI or their condensation products, a catalyst such as tertiary amine and a solution containing the fluoropolymer polyol. The three components may simply be mixed together to form the polyisocyanate solution which reacts to form a urethane coating. The fluoropolymer polyol and polyisocyanate are typically mixed in approximately equal equivalent weights and generally provide a ratio of NCO to OH of from 1.0:1.1 to 1.1:1.0

A solvent is typically used and suitable solvents are inert and provide evaporation. Typical solvents include esters such as butyl acetate and aryl acetate; ketones such as methyl ethyl ketone and methyl isobutyl ketone and aromatic hydrocarbons such as xylene and toluene. One preferred solvent is a mixture of ethyl acetate, methyl isobutyl ketone and ethylene glycol monoethyl ether acetate in a ratio of 20:20:60 volume percent respectively. The catalyst may be any of the suitable urethane catalyst such as dimethylbenzylamine and organometalic such as dibutyl tin dilaurate.

Epoxy resin coatings may be formed from two component systems in which the first component is a solution of the epoxypolymer in a solvent and optionally containing pigments and/or extenders and a second component containing a curing agent for the epoxy.

The curing agent will promote cross linking of the epoxy and typically includes an aromatic or aliphatic primary or secondary amine or an organic acid anhydride. Acid anhydrides are generally used with a catalyst in amounts of from 0.15 to 0.60 weight percent catalyst based on the weight of epoxy solution. Dimethylbenzlamine is the preferred catalyst.

Typical curing conditions for epoxy compositions involve heating to a temperature of from 20° C. to 40° C. for three to four hours followed by post cure heating to 55 to 70° C. for about one hour. When an anhydride such as a phthalic anhydride or derivative is used curing conditions of 75 to 85° C. are typical followed by post cure heating to 110 to 130° C. for about 3 hours.

The fluorinated epoxy of the invention may be modified to form a oligomer having unsaturated groups such as acrylate or methacrylate groups.

Accordingly in a further embodiment the fluoropolymer of formula II

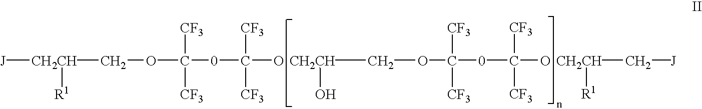

R¹ is hydrogen or hydroxy

wherein J is

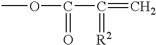

or O—CH═CH₂

wherein R² is hydrogen or methyl and n is as hereinbefore defined.

The fluoropolymer may further comprise two or more epoxy polymers linked by urethane linkages and comprising terminal unsaturated groups.

The unsaturated oligomers of this aspect of the invention may be acrylic compositions may be in the form of thermocurable acrylics, non-aqueous dispersions or may be adapted to be cured by radiation such as actinic radiation or electronbeam radiation. Acrylic formulations may additionally include a solvent or reactive monomers such as polyacrylate monomers which may be fluorinated.

Pigments may be used in the compositions of the invention. Examples of suitable pigments include titanium dioxide, phthalocyanine blue, carbon black and particulate aluminium.

Other pigments which may be used are the white hiding pigments, such as basic carbonate white lead, basic silicate white lead, basic sulfate white lead, zinc oxide, leaded zinc oxide, antimony oxide and lithopone. Extender pigments can be used as well. Among these are the hydrated aluminum silicates, magnesium silicate (talc), silica, calcium carbonate, barium sulfate, calcium sulfate and powdered mica. Should color be desired the color pigments may be used. These are classified as natural pigments, synthetic inorganic pigments and synthetic organic pigments.

The natural pigments comprise the inorganic earth colors or mined products and a few organic materials of vegetable and animal origin. Of chief importance are the iron compounds, composed mainly of iron oxides in combination with siliceous material and smaller percentages of the oxides of manganese, aluminum, calcium, and/or magnesium, together with some carbonaceous matter. These ferro-ferric oxide pigments include the yellow ochers, the dark yellow siennas, the brown umbers, the rod hematites and burnt siennas, and the black magnetite or magnetic oxide.

The synthetic inorganic pigments contemplated are the iron oxides, iron blues such as ferric-ferrocyanides, chromate pigments, chrome greens, chromium oxides and their hydrates, ultramarine blue, and cadmium yellow and reds.

The synthetic organic pigments are the copper phthalocyanine blues and greens, toluidine reds, para reds, lithol reds, yellows, benzidine yellows, tungstated and molybdated pigments.

An important group of pigments are those used entirely for their ability to inhibit metallic corrosion. These include red lead (Pb₃O₄), sublimed blue lead (basic lead sulfate, blue), calcium plumbate, basic lead chromate, zinc chromate (zinc yellow), zinc tetroxychromate, and strontium chromate.

Metallic pigments for use in paints are usually in flake form. A useful metallic pigment is aluminum. Metallic copper and its alloys with aluminum tin or zinc yield a bronze finish. Zinc dust is useful as gold and silver flake and stainless steel flake. The invention further contemplates the use of black pigments and fluorescent pigments.

The invention will now be described with reference to the following example. It should be understood, however, that the description is illustrative only and should not be taken in any way as a restriction on the general nature of the invention.

### EXAMPLE 1

The aromatic diol used was a mixture of 1,3-bis and 1,4-bis(2-hydroxyhexafluoro-2-propyl)benzene which may be prepared by the synthesis of Farah et al J. Org. Chem. 30, 998 (1965).

The aromatic diol was reacted with an equivalent amount of epichlorohydrin and a 10% excess of sodium hydroxide by refluxing in acetone containing a small amount of water. Gas chromatography may be used to monitor the progress of the reaction. On completion of the reaction acetone was removed and the epoxy polymer washed with excess water and dried. The polymer may be dissolved into solvent such as a 20:20:60 volume % blend of ethylacetate, methyl isobutyl ketone and ethylene glycol monoethyl ether acetate at 50% by weight. A fluorinated polyurethane resin composition was prepared by addition of polyisocyanate TDI at a ratio of NCO to OH of about 1:1 catalyst (listing amine).

Example 2 to 4

The fluorinated polyurethane of Example 1 was used to prepare a resin composition by mixing the fluorinated polyurethane of Example 1 (FPU) containing 60-70% solids with other resins as shown.

### EXAMPLE 2

| | |
|---|---|
| PARALOID AU 6085 acrylic urethane solution | 121.25 kg |
| (Rohn & Haas) | |
| FPU | 3 kg |

### EXAMPLE 3

| | |
|---|---|
| DESMOPHEN 651 polyester resin solution (Bayer) | 74.62 kg |
| DESMOPHEN 670 polyester resin solution (Bayer) | 22.38 kg |
| FPU | 3 kg |

### EXAMPLE 4

| | |
|---|---|
| DESMOPHEN 800 polyester resin solution (Bayer) | 45 kg |
| DESMOPHEN 1100 polyester resin solution (Bayer | 45 kg |
| FPU | 10 kg |

Example 5 to 7

The resin compositions of Examples 2 to 4 were used to prepare coating compositions of Examples 5 to 7 with the compositions described.

### EXAMPLE 5

The coating composition of this example is a 5 component polyurethane which includes

| | |
|---|---|
| Component A | |
| Resin solution of Example 3 | 100 kg |
| Titanium dioxide | 104 kg |
| Solvent | 85 kg |
| Component B | |
| ‘Bayer N-75’ (HD1 polyisocyanide) | 73.3 kg |
| Solvent | 34 kg |

### EXAMPLE 6

The coating composition of this example is a two component polyurethane prepared from the resin composition of Example 2

| | |
|---|---|
| Component A | |
| Resin solution of Example 2 | 100 kg |
| Titanium dioxide | 108 kg |
| Solvent | 91 kg |
| Component B | |
| Bayer ‘N-75’ | 26.8 kg |
| Solvent | 23 kg |

### EXAMPLE 7

The coating composition of this example may be used to provide a very high level of chemical resistance.

| | |
|---|---|
| Component A | |
| Resin solution of Example 5 | 100 kg |
| PTFE powder (>6 micron average size) | 116 kg |
| Titanium dioxide | 64 kg |
| Solvent | 120 kg |
| Component B | |
| ‘Bayer N-75’ | 119 kg |

### EXAMPLE 8

The epoxy polymer prepared by the method of Example 1 may be used to prepare an epoxy resin by mixing 3% by weight of the resin with 97% by weight of aromatic hydrocarbon epoxy such as bisphenol A epoxy resin.

The fluoropolymer composition may be in the form of an extendable plastic for use in forming a protective layer on pipes, bearings or corrosion resistant fittings.

Finally, it is to be understood that various other modifications and/or alterations may be made without departing from the spirit of the present invention as outlined herein.

1. A fluoropolymer of Formula I 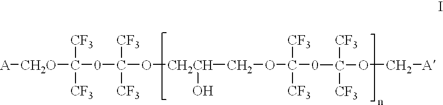
wherein
ø is an aromatic diradical;
n is an integer of at least 2; and
A and A′ are independently selected from the group consisting of 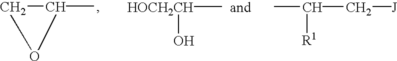
wherein R¹ is hydrogen or hydroxy and J is 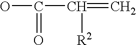
or —O—CH═CH₂
wherein R² is hydrogen or methyl.

2. A fluoropolymer according to claim 1 wherein the group ø is a meta- or para-diradical of benzene.

3. A fluoropolymer according to claim 1 wherein n is an integer of from 4 to 40.

4. A fluoropolymer according to claim 1 wherein n is an integer of from 8 to 20.

5. A fluoropolymer according to claim 1 prepared by reaction of 1,3-bis(2-hydroxhexafluoro-2-propyl)benzene, 4-bis(2-hydroxyhexafluoro-2-propyl)-benzene or a mixture thereof with epichlorohydrin and sodium hydoxide.

6. A fluoropolymer accoreing to claim 5 wherein the epichlorohydrin and sodium hydroxide are present in a molar access of at least 10% based on the bis(2-hydroxyhexafluoro-2-propyl)benzene monomer.

7. A fluoropolymer according to claim 5 wherein A and A′ are

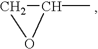

8. A fluoropolymer according to claim 6 wherein A and A′ are independently selected from 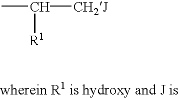
wherein R¹ is hydroxy and J is 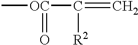
or —O—CH═CH₂
wherein R² is hydrogen or methyl.

9. A coating composition comprising the fluoropolymer of claim 1 and a solvent or diluent.

10. A coating composition according to claim 9 comprising the fluoropolymer of claim 1 with a polyisocyanate and catalyst.

11. A coating composition comprising the fluoropolymer of claim 1 and a curing agent selected from the group consisting of aromatic primary amines, aromatic secondary amines, aliphatic primary amines, aliphatic secondary amines and organic acid anhydrides.
